(19) United States
(12) Patent Application Publication
(10) Pub. No.: US 2024/0154805 A1
(43) Pub. Date: May 9, 2024

(54) SYSTEMS AND METHODS FOR BLOCKCHAIN-BASED DOMAIN REGISTRATION AND DEVICE AUTHENTICATION

(71) Applicant: Verizon Patent and Licensing Inc., Basking Ridge, NJ (US)

(72) Inventors: Young Rak CHOI, Belle Mead, NJ (US); Warren Hojilla UY, Randolph, NJ (US); Dayong HE, Bridgewater, NJ (US); Manuel Enrique CACERES, Basking Ridge, NJ (US)

(73) Assignee: Verizon Patent and Licensing Inc., Basking Ridge, NJ (US)

(21) Appl. No.: 18/053,623

(22) Filed: Nov. 8, 2022

(51) Int. Cl. H04L 9/30; H04L 9/32

(52) U.S. Cl. CPC H04L 9/30; H04L 9/3247

(57) ABSTRACT

In some implementations, a device may receive a request to add a domain to a blockchain. The request may include data that indicates a public key associated with the domain and/or a unique identifier associated with the domain. The device may generate a domain information block, based on the request, that includes the public key associated with the domain and a blockchain identifier that is based on the unique identifier associated with the domain. The device may provide the domain information block to a set of blockchain nodes to add the domain information block to the blockchain.

### BACKGROUND

A registrant may register a domain name with a domain name registry via a domain name registrar. The domain name registry may store information associated with the registrant and/or the domain name. The information associated with the registrant and/or the domain name may be queried for various purposes, such as to obtain information about domain name registration records.

### BRIEF DESCRIPTION OF THE DRAWINGS

FIGS. 1A-1E are diagrams of an example associated with blockchain-based domain registration and device authentication.

FIG. 2 is a diagram of an example associated with blockchain-based domain registration and device authentication.

FIG. 3 is a diagram of an example environment in which systems and/or methods described herein may be implemented.

FIG. 4 is a diagram of example components of a device associated with blockchain-based domain registration and device authentication.

FIG. 5 is a flowchart of an example process associated with blockchain-based domain registration and device authentication.

### DETAILED DESCRIPTION OF EXAMPLE EMBODIMENTS

The following detailed description of example implementations refers to the accompanying drawings. The same reference numbers in different drawings may identify the same or similar elements.

Devices may use a secure communication protocol, such as Hypertext Transfer Protocol Secure (HTTPS), to securely communicate with other devices over a network. To secure the communications between the devices, HTTPS may utilize a security protocol, such as a Secure Sockets Layer (SSL) protocol or a Transport Layer Security (TLS) protocol, for authentication and to encrypt data that is exchanged between the devices over the network. The SSL protocol and the TLS protocol, which may be referred to herein as SSL/TLS, may utilize an SSL/TLS handshake protocol and/or an SSL/TLS record protocol to establish the secure communications between the devices. The SSL/TLS handshake protocol may include using asymmetric cryptography to authenticate information associated with the devices and/or negotiate a symmetric key that is used to encrypt data that is exchanged between the devices. After establishing a connection via the SSL/TLS handshake protocol, the devices may perform the SSL/TLS record protocol to secure (e.g., encrypt) data that is exchanged between the devices (e.g., based on the symmetric key).

In some cases, the SSL/TLS protocol may be based on a public key infrastructure (PKI), which is a security architecture based on certificates (also called digital certificates or public key certificates) and public key encryption. The PKI infrastructure may be associated with a certificate authority (CA), a registration authority (RA), and/or a validation authority (VA).

The CA in a PKI may issue a certificate in response to a request for a certificate from a certificate requestor (e.g., an individual and/or an organization). For example, the certificate requestor may generate a key pair that includes a public key and a private key. The private key may be used to create digital signatures and/or to decrypt data that is encrypted with the corresponding public key. The public key may be used to verify digital signatures created with the corresponding private key and/or to encrypt messages that can be decrypted only with the corresponding private key.

The certificate requestor may send a message to the CA to request the certificate from the CA. The message may include the public key held by the certificate requestor, identity information associated with the certificate requestor (e.g., a name of an organization), and/or a digital signature created by the certificate requestor using the private key held by the certificate requestor. The digital signature created using the private key may be verified (e.g., validated) using the corresponding public key held by the certificate requestor.

The CA may validate the identity information and issue a certificate to the certificate requestor based on validating the identity information. The issued certificate may bind the identity information to the public key held by the certificate requestor (e.g., the identify information may be bound to an owner of a domain name). The issued certificate may be associated with a validity period that defines a time period that the certificate is valid (e.g., the time period may be from an issue date associated with the certificate to an expiry date associated with the certificate).

The CA may delegate tasks to the RA to be performed by the RA. For example, tasks that may be delegated to, and performed by, the RA may include identifying and authenticating certificate applicants, approving or rejecting certificate applications, initiating certificate revocations or suspensions, processing requests to revoke or suspend certificates, and/or approving or rejecting requests to renew or re-key certificates.

The VA may verify the validity of a certificate issued by the CA. For example, the CA may provide information associated with revoked certificates to the VA, and the VA may publish a list of the revoked certificates. The list of revoked certificates may be used to determine whether a certificate is valid (e.g., the certificate is valid if the certificate is not listed in the list of revoked certificates).

In some cases, the CA may be a root CA that issues intermediate certificates (e.g., subordinate certificates) to intermediate CAs (e.g., subordinate CAs). The root CA may issue a root certificate (e.g., a self-signed certificate issued by the root CA) that identifies the root CA and that facilitates verification of certificates issued to the intermediate CAs. The root certificate and one or more intermediate certificates may form a certification chain. As an example, the root CA may issue a root certificate that begins the certification chain, and the root certificate may be used as a private key to digitally sign intermediate certificates issued by an intermediate CA. The intermediate certificates issued by intermediate CAs may be trusted based on the root certificate issued by the root CA.

A certificate issued by the intermediate CA may be validated by comparing the intermediate CA to a list of trusted CAs. If the intermediate CA is not listed in the list of trusted CAs, the certificate chain may be checked to determine whether the certificate issued by the intermediate CA was issued by an ordinate trusted CA. This process may continue until a trusted CA is identified, which may be the root CA that issues the root certificate (e.g., root CAs may typically be trusted).

In some cases, the CA may issue SSL/TLS certificates that may be used for authentication and/or for establishing secure communication between devices. For example, SSL/TLS certificates may include server certificates (e.g., stored on a server side) and/or root certificates (e.g., stored on a client side) that may be used to authenticate a web server and/or to establish secure communications between the web server and a client device.

As an example, an organization may operate and/or control a web server associated with a domain. The web server may generate a key pair that includes a public key and a private key associated with the web server. The organization may request a server certificate associated with the web server from the CA.

The CA may validate the information in the request and may issue the server certificate to the organization. The server certificate may bind identity information associated with the web server (e.g., a domain name of the domain associated with the web server) to the public key.

In some cases, a client device, such as a web browser, may initiate an SSL/TLS handshake protocol with the web server by sending the web server a message. The web server may provide the server certificate to the client device in response to receiving the message. The client device may use the server certificate to authenticate the identity information indicated by the server certificate (e.g., the domain name of the domain associated with the web server).

To authenticate the identity information, the client device may verify that the server certificate is valid (e.g., a current date is within the validity period associated with the server certificate), may verify that the issuing CA is a trusted CA (e.g., the CA is listed in a list of trusted Cas), may verify that the public key from the certificate of the issuing CA validates the digital signature of the CA on the server certificate, and/or may verify the domain name of the domain associated with the web server (e.g., by retrieving information directly from a domain name registrar via a secure retrieval protocol).

As another example, the client device may store a root certificate on the client side (e.g., in a trust store). The client device (e.g., via the web browser) may initiate the SSL/TLS handshake protocol with the web server by sending the web server a message. The web server may provide the server certificate to the client device during the SSL/TLS handshake in response to the message.

The client device may use the root certificate to authenticate the identity information indicated by the server certificate (e.g., the domain name of the domain hosted by the web server). For example, the client device may use the root certificate to verify the server certificate and a certification chain associated with the server certificate (e.g., using the root certificate, which is issued by the CA and includes the public key of the CA). After verifying the server certificate, the client device and the web server may use the SSL/TLS record protocol to securely exchange data over the network.

However, in some cases, devices that use SSL/TLS certificates for authentication and/or for establishing secure communications consume resources (e.g., computing resources, memory resources, networking resources, and/or other resources) associated with managing the SSL/TLS certificates. For example, because server certificates are typically valid for a limited time period (e.g., one year), devices consume resources to identify expiry dates associated with the server certificates and/or to process renewals associated with the server certificates.

As another example, because root certificates are typically valid for a limited time period (e.g., thirty years), devices that store the root certificates typically become obsolete and/or need to be replaced by the time that the root certificate expires, or, in some cases, before the root certificate expires. Thus, devices may consume resources associated with replacing devices and/or root certificates based on the limited validity period.

In some cases, a root certificate associated with a root CA may become invalid. For example, if the root CA experiences a data breach and/or does not follow proper procedures that results in the root CA improperly issuing a root certificate, the entire certificate chain associated with the root certificate may need to be replaced (e.g., each intermediary certificate and the root certificate needs to be replaced). Thus, devices may consume resources associated with replacing the certificates associated with a root CA that becomes invalid.

In some cases, SSL/TLS certificates may need to be replaced based on updates and/or changes to cryptographic algorithms and/or key sizes associated with the SSL/TLS certificates. As such, devices may consume resources associated with replacing SSL/TLS certificates associated with updated, replaced, and/or deprecated cryptographic algorithms and/or key sizes.

Some implementations described herein may provide systems and methods for blockchain-based domain registration and device authentication (e.g., server authentication) that are independent from certificates (e.g., SSL/TLS certificates). In this way, the systems and methods described herein consume less resources compared to certificate-based authentication techniques. For example, some implementations may provide domain information that is added to a blockchain, and the domain information may be used for authentication and/or for establishing secure communications. As a result, the devices do not need to acquire certificates, exchange certificates, or manage certificates.

As an example, some implementations described herein may provide domain information associated with a domain to a blockchain based on a request that indicates a public key associated with the domain and a unique identifier (e.g., a domain name) associated with the domain. In some implementations, a domain information block may be generated based on the request that includes the public key and a blockchain identifier that is based on the unique identifier. The domain information block may be provided to a set of blockchain nodes to add the domain information block to the blockchain. Thus, the domain information that is added to the blockchain is immutable, which enables the domain information to be relied on for various purposes, such as authentication.

In some implementations, the blockchain may include one or more forks such that the blockchain includes a plurality of layers. As an example, the plurality of layers may be associated with one or more parameters (e.g., one or more top-level domains and/or one or more blockchain identifiers) and the domain information block may be added to the blockchain based on the one or more parameters associated with the plurality of layers. In this way, some implementations provide flexible and/or scalable techniques associated with authentication and/or secure communication (e.g., mitigating performance issues that may occur when a large number of domain names are registered on the blockchain).

In some implementations, a device, such as a client device, may authenticate another device, such as a network device, based on the domain information block that is on the blockchain. For example, the client device may provide a message to a network device that indicates a random parameter.

The client device may receive a message from the network device that includes a digital signature based on the random parameter and a blockchain identifier associated with a domain that corresponds to the device. The client device may obtain information associated with the domain that corresponds to the device (e.g., a domain name and a public key associated with the domain) from a blockchain based on the blockchain identifier. The client device may verify the domain name and/or the digital signature (e.g., the digital signature may be verified using the public key). The client device may authenticate the network device based on verifying the domain name and/or the digital signature. The client device and the network device may perform additional operations to begin exchanging secure communications with one another.

In this way, some implementations described herein provide flexible and scalable authentication and secure communication techniques. Further, because some implementations described herein use blockchain-based techniques for authentication and/or secure communication, less resources are consumed compared to certificate-based authentication and/or secure communication techniques (e.g., by avoiding a need to acquire certificates, exchange certificates, and/or manage certificates).

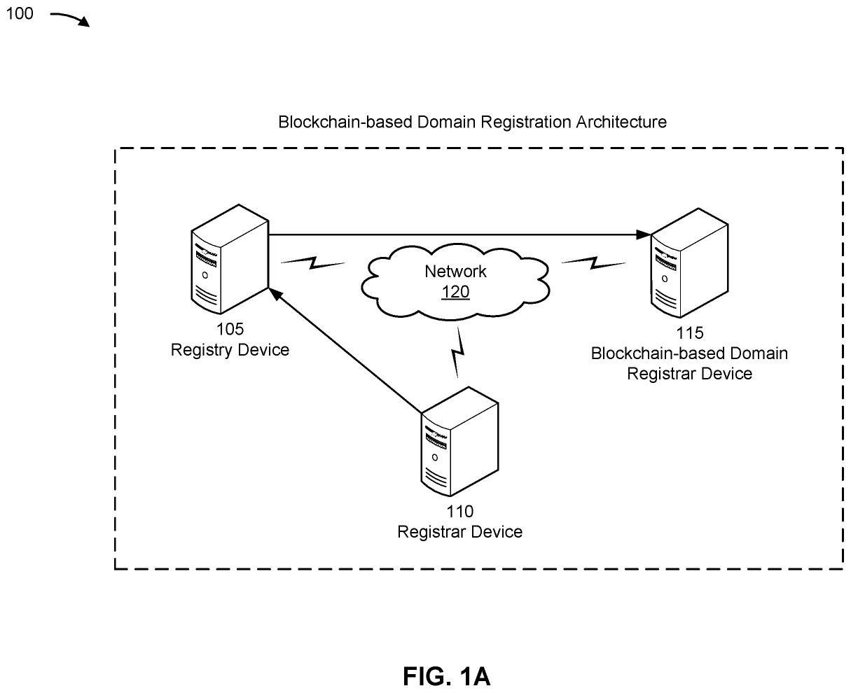

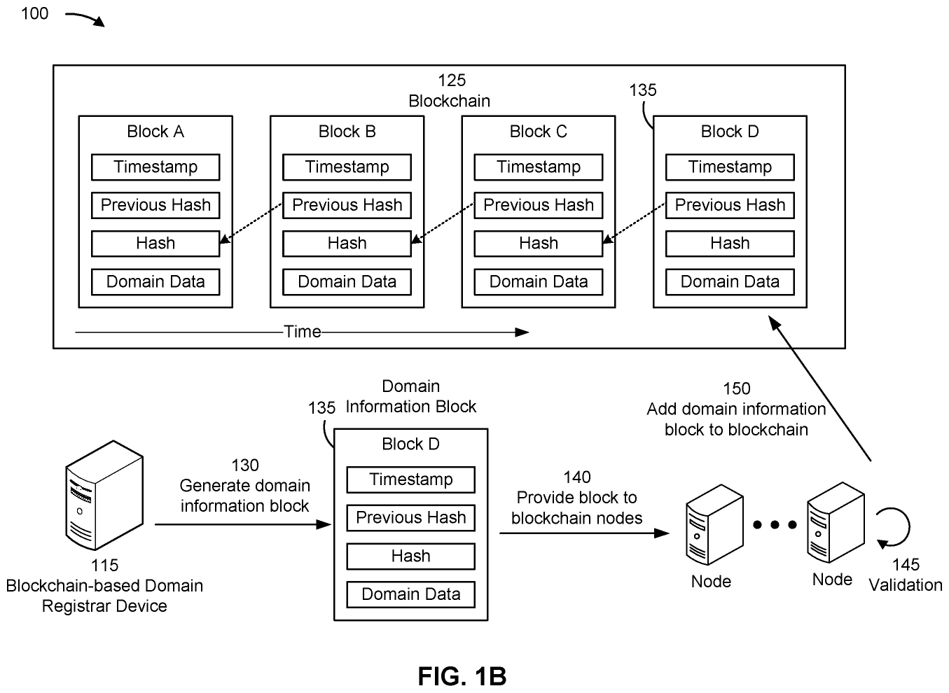

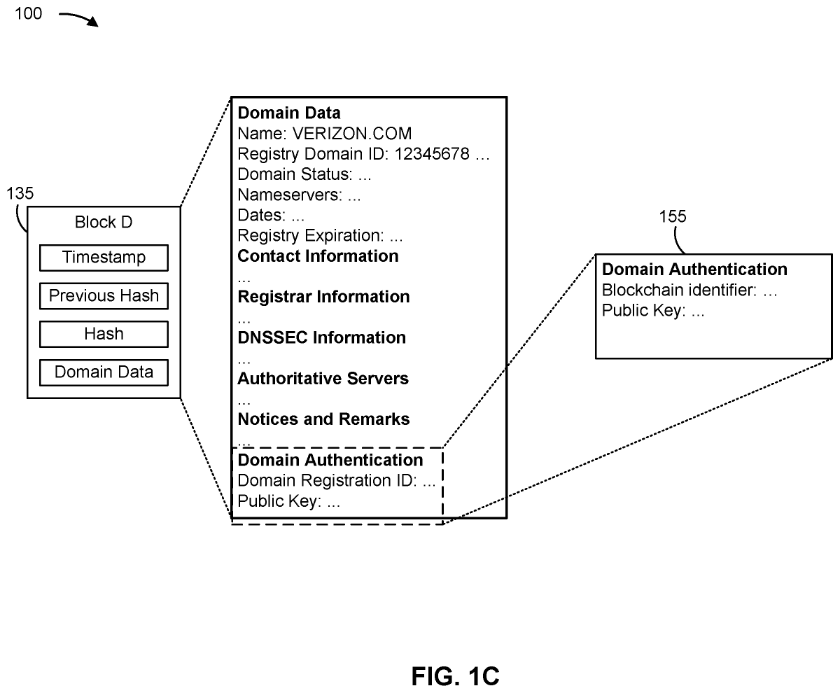

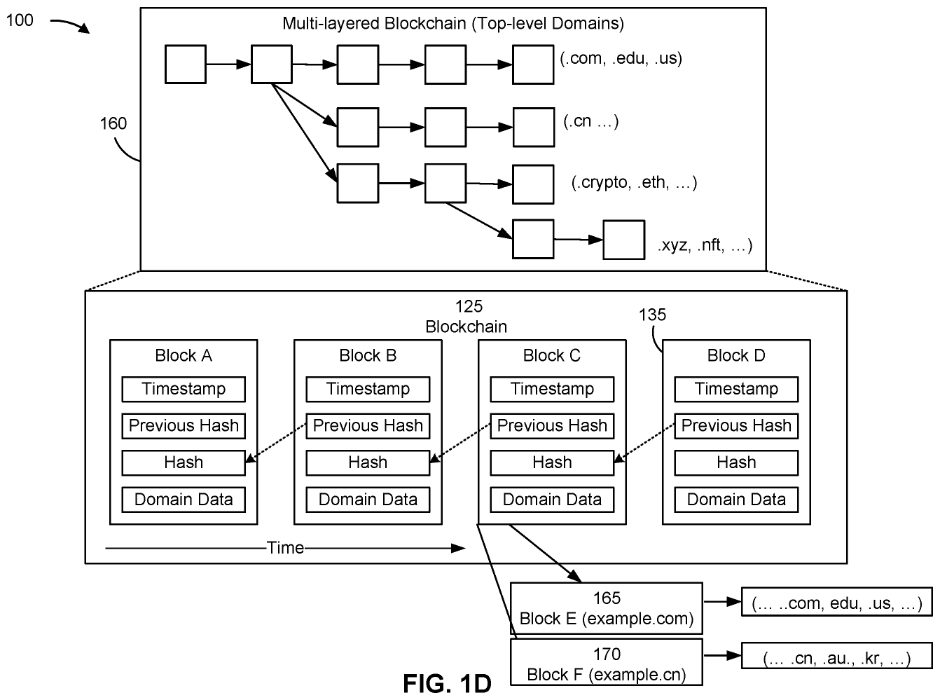

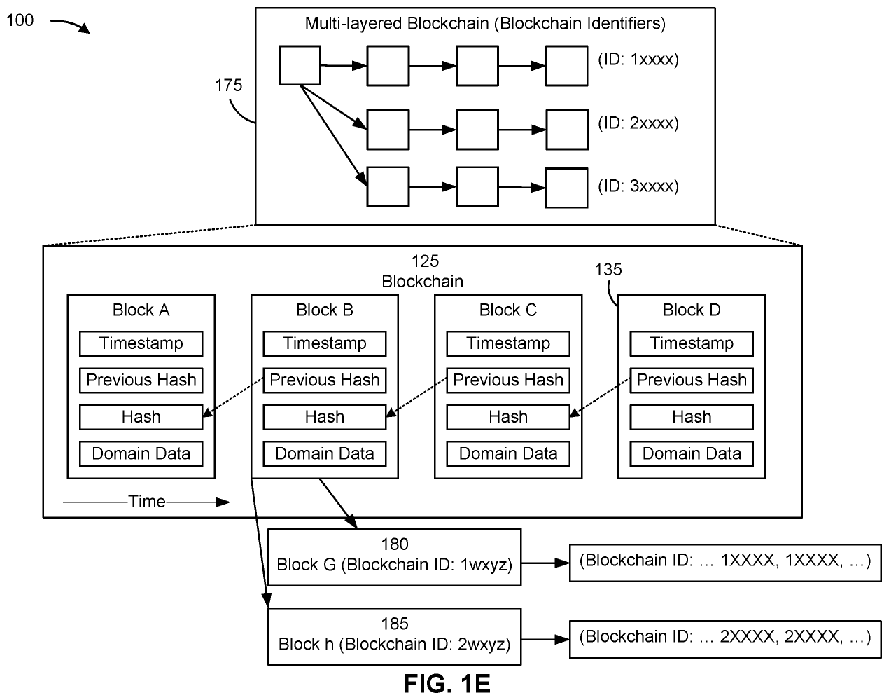

FIGS. 1A-1E are diagrams of an example 100 associated with blockchain-based domain registration and device authentication. As shown in FIGS. 1A-1E, example 100 includes a registry device 105, a registrar device 110, a blockchain-based domain registrar device 115, and/or a network 120.

As shown in FIG. 1A, for example, the blockchain-based domain registrar device 115 may communicate with the registry device 105 and/or the registrar device 110 over the network 120 to implement a blockchain-based domain registration architecture. In some implementations, the blockchain-based domain registration architecture may register domain names and/or store domain information on a blockchain 125 (e.g., as shown in FIGS. 1B-1E and described in further detail herein). The domain information may be used to authenticate a device, such as a network device, as described in more detail elsewhere herein.

As an example, a network device, such as web server, may be communicatively coupled to the blockchain-based registrar device 115 and configured to transmit domain information to the blockchain-based registrar device 115. The domain information may include a domain name associated with the network device and/or a public key associated with the network device.

A client device, such as a web browser, may initiate an SSL/TLS handshake protocol with the network device to authenticate the web server and/or to establish secure communications with the network device. In some implementations, the client device may authenticate the network device during the SSL/TLS handshake protocol based on the domain information, as described in more detail elsewhere herein. In this way, the blockchain-based domain registration architecture may enable authentication operations to be performed without the use of certificates, such as server certificates stored on a server side and/or root certificates stored on a client side.

In some implementations, the registry device 105 may maintain administrative data associated with generic top-level domains (gTLDs), such as .com, .edu, .net, and/or .org, and/or lower-level domains. As an example, the registry device 105 may obtain the administrative data from the registrar device 110, as described in more detail elsewhere herein.

In some implementations, the registrar device 110 may be communicatively coupled to the registry device 105 to exchange information associated with the gTLDS and/or the lower-level domains. For example, the registrar device 110 may obtain domain information from a domain name registrant, such as an individual and/or an organization. The domain information may include a domain name, a registry domain identifier, a domain status, a nameserver, a registry expiration date, contact information, registrar information, Domain Name System Security Extensions (DNSSEC) information, authoritative servers, and/or notices and remarks.

As an example, the registrar device 110 may transmit, and the registry device 105 may receive, the domain information. The registry device 105 may register the domain name with a registry via a registry operator. For example, the Internet Corporation for Assigned Names and Numbers (ICANN) may delegate control of a top-level domain (e.g., a gTLD) to a registry operator, and the registry operator may maintain a record of all domain names registered in the top-level domain controlled by the registry operator.

In some implementations, the registrar device 110 may store and/or maintain the domain information. For example, the registrar device 110 may store the domain information in a database associated with the registrar and/or in a database associated with ICANN. The registrar device 110 may update the domain information and/or provide public access to the domain information.

In some implementations, the blockchain-based registrar device 115 may obtain the domain information (e.g., from a device associated with the registrant). The blockchain-based domain registrar device 115 may provide the domain information to a set of blockchain nodes to add the domain information to the blockchain such that the domain information associated with the registry device 105 and/or the domain information associated with the registrar device 110 may be validated based on the domain information that is added to the blockchain, as described in more detail elsewhere herein.

For example, the registry device 105 and/or the registrar device 110 may be associated with information that can be verified based on information associated with the blockchain-based domain registrar device 115 and/or information on the blockchain 125.

As shown in FIG. 1B, some operations of example 100 may be performed by multiple blockchain nodes. The blockchain nodes may form a blockchain network, and the blockchain 125 may be distributed among the blockchain nodes of the blockchain network. The blockchain 125 may be a distributed ledger, or database, that maintains a list of records, called blocks, that may be linked together to form a chain structure.

As shown in FIG. 1B, and by reference number 130, the blockchain-based domain registrar device 115 may generate a domain information block 135. For example, the blockchain-based domain registrar device 115 may generate the domain information block 135 in response to receiving a request to register a domain on the blockchain 125. The request to register the domain on the blockchain 125 may include data that indicates a public key associated with the domain and/or a unique identifier associated with the domain.

As an example, a registrant, such as an organization, may generate a key pair associated with the domain, where the key pair includes the public key and a corresponding private key associated with the domain. The private key may be used to create digital signatures and/or to decrypt data that is encrypted with the corresponding public key. The public key may be used to verify digital signatures created with the corresponding private key and/or to encrypt messages that can be decrypted only with the corresponding private key. The unique identifier may be the domain name that is registered with the blockchain 125.

In some implementations, the blockchain-based domain registrar device 115 may generate a blockchain identifier that identifies the domain information block on the blockchain 125. Alternatively, the blockchain identifier may be generated by the blockchain nodes, such as when the domain information block is added to the blockchain 125.

In some implementations, the blockchain-based domain registrar device 115 may cause the domain information block 135 to be generated by a blockchain node. As shown, each block of the blockchain 125, including the domain information block 135, includes a timestamp, a previous hash, a hash, and domain data. The timestamp, the previous hash, and the hash associated with the blocks may form a header associated with the blocks. The hash of a block may be a hash representation (e.g., using one or more hashing methods) of the data included in the block (e.g., the domain data), and the previous hash may be the hash value in the header of the previous block.

For example, the previous hash in the header of Block B may be the hash value in the header of Block A, and so forth. Thus, the blocks forming the blockchain 125 may be chained together by each block referencing the hash value of the previous block. In this way, an altered block may be easily detected and rejected from the blockchain 125.

As further shown in FIG. 1B, and by reference number 140, the domain information block 135 may be provided (e.g., broadcast) to one or more (e.g., all) blockchain nodes in the blockchain network. As shown by reference number 145, the blockchain nodes may validate the domain information block 135. As an example, to validate the domain information block 135, the blockchain nodes may utilize one or more consensus techniques, which may utilize a proof of work (PoW) algorithm, a proof of stake (PoS) algorithm, a delegated proof of stake (DPoS) algorithm, and/or a practical Byzantine fault tolerance (PBFT) algorithm, among other examples. As shown by reference number 150, once the domain information block 135 has been validated, the blockchain nodes may add the domain information block 135 to their respective copies of the blockchain 125.

As shown in FIG. 1C, and by reference number 155, the domain information block 135 may include domain authentication information, which may include the blockchain identifier and the public key associated with the domain. Thus, in some implementations, in addition to information that is typically stored in a registry database and/or a registrar database (e.g., domain information, contact information, registrar information, DNSSEC information, authoritative servers, and/or notices and remarks), the domain information block 135 may include the domain authentication information that may be used for authentication and/or establishing secure communications, as described in more detail elsewhere herein.

As shown in FIG. 1D, the blockchain 125 may include one or more forks such that the blockchain 125 includes a plurality of layers (e.g., the blockchain 125 has a multi-layer structure). For example, as shown by reference number 160, each of the plurality of layers may be associated with one or more top-level domains (or domain extensions). For example, the one or more top-level domains may include gTLDs, sponsored top-level domains (sTLDs), country code top-level domains (ccTLDs), infrastructure top-level domains (iTLDs), and/or test top-level domains (tTLDs).

In some implementations, the domain information block 135 may be added to one of the plurality of layers based on a top-level domain associated with the domain being registered corresponding to a top-level domain included in the one or more top-level domains associated with the one of the plurality of layers. As an example, if the domain being registered is “example.com,” and if one of the plurality of layers is associated with the top-level domain “.com,” then the domain information block 135 may be added to the one of the plurality of layers that is associated with the top-level domain “.com.”

As shown by reference number 165, for example, Block E is associated with the domain name “example.com” and is therefore added to the layer that is associated with the top-level domain “.com.” As shown by reference number 170, Block F is associated with the domain name “example.cn” and is therefore added to the layer associated with the top-level domain “.cn.”

Additionally, or alternatively, as shown by reference number 175 in FIG. 1E, each of the plurality of layers may be associated with a range of blockchain identifiers. For example, the range of blockchain identifiers may include a first range of blockchain identifiers (shown as ID: 1xxxx), a second range of blockchain identifiers (shown as ID: 2xxxx), and a third range of blockchain identifiers (shown as ID: 3xxxx). However, it will be appreciated that the plurality of layers may be associated with more (e.g., four or more) or fewer (e.g., two) ranges in other examples.

In some implementations, the domain information block 135 may be added to one of the plurality of layers based on the blockchain identifier associated with the domain being registered being within the range of blockchain identifiers associated with the one of the plurality of layers. As an example, a first domain information block associated with a first blockchain identifier of “ID: 1abcd” may be added to the layer associated with the range indicated as “ID: 1xxxx,” a second domain information block associated with a second blockchain identifier of “ID: 2abcd” may be added to the layer associated with the range indicated as “ID: 2xxxx,” and/or a third domain information block associated with a third blockchain identifier of “ID: 3abcdD” may be added to the layer associated with the range indicated as “ID: 3xxxx.”

As shown by reference number 180, Block G is associated with the blockchain identifier “1wxyz” and is added to the layer associated with the blockchain identifier “ID: 1xxxx.” As shown by reference number 185, Block H is associated with the blockchain identifier “2wxyz” and is added to the layer associated with the blockchain identifier “ID: 2xxxx.”

In some implementations, at least one of the plurality of layers may be associated with one or more domain expiration events. For example, the one or more domain expiration events may include one or more expiration dates associated with one or more domain names. For example, if a domain name expires on a particular date, then the domain expiration event may be the particular date. In this example, the domain information block 135 associated with the expiration event on the particular date may be added to the at least one layer associated with the one or more expiration events. In some implementations, the domain information block 135 may include an indication of the domain expiration event (e.g., a particular expiration date) and may be added to the at least one of the plurality of layers based on the domain expiration event.

In this way, the blockchain-based domain registration techniques described herein provide flexible and/or scalable authentication and/or secure communication techniques. Further, because some implementations described herein use blockchain-based techniques for authentication and/or secure communication, less resources are consumed compared to certificate-based authentication and/or secure communication techniques.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

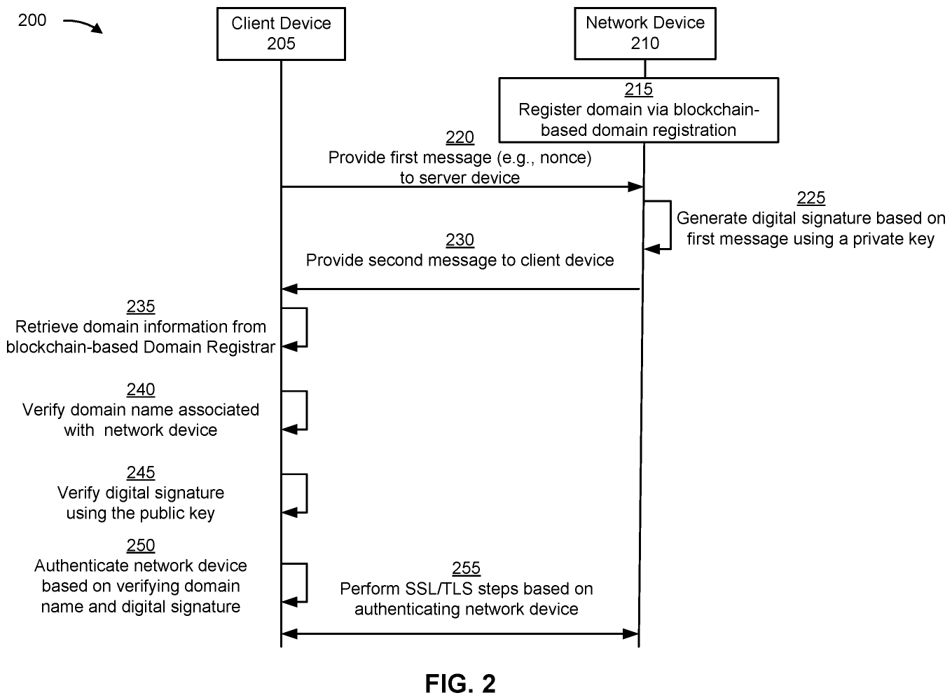

FIG. 2 is a diagram of an example 200 associated with blockchain-based domain registration and device authentication. As shown in FIG. 2, example 200 includes communication between a client device 205 and a network device 210.

As shown in FIG. 2, and by reference number 215, the network device 210 may register a domain on a blockchain via blockchain-based domain registration (e.g., as described above with reference to FIGS. 1A-1E). For example, the network device may be a web server associated with an organization, and the organization may register a domain associated with a domain name of the web server (e.g., “example.com”) on the blockchain via the blockchain-based domain registration.

As shown by reference number 220, the client device 205 may provide, and the network device 210 may receive, a first message (e.g., a client “Hello” message). For example, the client device 205 may generate a random parameter or nonce (e.g., a timestamp or a visit counter on a webpage), and may transmit the random parameter or nonce to the network device 210. In some implementations, the client device 205 may provide the random parameter or nonce to prevent another malicious device from performing a replay attack.

As shown by reference number 225, the network device 210 may generate a digital signature based on the first message using a private key held by the network device 210. For example, the network device 210 may create a digital signature of the first message (e.g., may digitally sign the first message) using the private key held by the network device 210.

As shown by reference number 230, the network device 210 may provide, and the client device 205 may receive, a second message (e.g., a server “Hello” message). In some implementations, the second message may indicate the digital signature created by the network device 210 and/or a blockchain identifier that is based on a unique identifier associated with the domain that corresponds to the network device 210.

In some implementations, the blockchain identifier may enable the client device 205 to retrieve a public key associated with the domain from a blockchain and to validate the digital signature using the public key. For example, the client device 205 may obtain the domain name and the public key associated with the domain from a blockchain based on the blockchain identifier. As an example, the client device 205 may perform a query associated with the blockchain based on the blockchain identifier, and a search result associated with the query may indicate the domain information block associated with the blockchain identifier. Accordingly, the client device 205 may obtain the domain name and the public key associated with the domain from the domain information block indicated by the search result associated with the query.

As shown by reference number 240, the client device 205 may verify the domain name associated with the network device. In some implementations, the client device 205 may perform a search based on retrieving the domain name. For example, the client device 205 may perform a query based on a query and response tool that queries domain registration information stored in public databases, such as a WHOIS query and/or a Registration Data Access Protocol (RDAP) query.

As shown by reference number 245, the client device 205 may verify the digital signature using the public key. For example, the client device 205 may decrypt the digital signature using the public key that the client device 205 retrieves from the blockchain to obtain a first value, may compute a hash value of the second message to obtain a second value, and may compare the first value with the second value. The client device 210 may verify the digital signature based on the first value matching the second value.

As shown by reference number 250, the client device 205 may authenticate the network device. For example, the client device 205 may authenticate the network device 210 based on verifying the domain name and verifying the digital signature associated with the network device 210.

As shown by reference number 255, the client device 205 and/or the network device 210 may perform SSL/TLS-based techniques based on authenticating the network device 210. For example, the client device 205 and the network device may perform the SSL/TLS record protocol after the network device 210 is authenticated.

As indicated above, FIG. 2 is provided as an example. Other examples may differ from what is described in connection with FIG. 2.

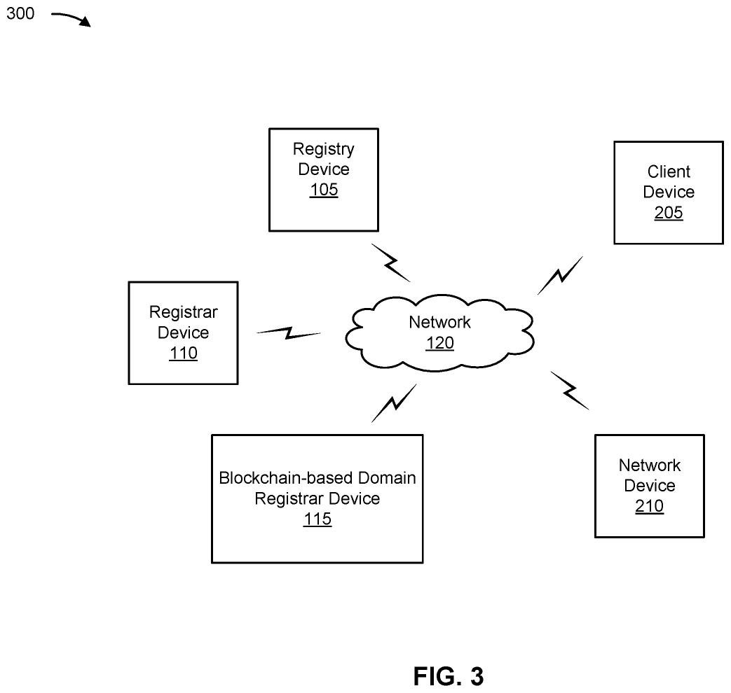

FIG. 3 is a diagram of an example environment 300 in which systems and/or methods described herein may be implemented. As shown in FIG. 3, environment 300 may include a registry device 105, a registrar device 110, a blockchain-based domain registrar device 115, a network 120, a client device 205, and/or a network device 210, and/or a network 120. Devices of environment 300 may interconnect via wired connections, wireless connections, or a combination of wired and wireless connections.

The registry device 105 may include one or more devices capable of receiving, generating, storing, processing, providing, and/or routing information associated with blockchain-based domain registration and device authentication, as described elsewhere herein. The registry device 105 may include a communication device and/or a computing device. For example, the registry device 105 may include a server, such as an application server, a client server, a web server, a database server, a host server, a proxy server, a virtual server (e.g., executing on computing hardware), or a server in a cloud computing system. In some implementations, the registry device 105 may include computing hardware used in a cloud computing environment.

The registrar device 110 may include one or more devices capable of receiving, generating, storing, processing, providing, and/or routing information associated with blockchain-based domain registration and device authentication, as described elsewhere herein. The registrar device 110 may include a communication device and/or a computing device. For example, the registrar device 110 may include a server, such as an application server, a client server, a web server, a database server, a host server, a proxy server, a virtual server (e.g., executing on computing hardware), or a server in a cloud computing system. In some implementations, the registrar device 110 may include computing hardware used in a cloud computing environment.

The blockchain-based domain registrar device 115 may include one or more devices capable of receiving, generating, storing, processing, providing, and/or routing information associated with blockchain-based domain registration and device authentication], as described elsewhere herein. The blockchain-based domain registrar device 115 may include a communication device and/or a computing device. For example, the blockchain-based domain registrar device 115 may include a server, such as an application server, a client server, a web server, a database server, a host server, a proxy server, a virtual server (e.g., executing on computing hardware), or a server in a cloud computing system. In some implementations, the blockchain-based domain registrar device 115 may include computing hardware used in a cloud computing environment.

The network 120 may include one or more wired and/or wireless networks. For example, the network 120 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 120 enables communication among the devices of environment 300.

The client device 205 may include one or more devices capable of receiving, generating, storing, processing, and/or providing information associated with blockchain-based domain registration and device authentication, as described elsewhere herein. The client device 205 may include a communication device and/or a computing device. For example, the client device 205 may include a user equipment, such as a wireless communication device, a mobile phone, a laptop computer, a tablet computer, a desktop computer, a wearable communication device (e.g., a smart wristwatch, a pair of smart eyeglasses, a head mounted display, or a virtual reality headset), or a similar type of device.

The network device 210 may include one or more devices capable of receiving, processing, storing, routing, and/or providing traffic (e.g., a packet and/or other information or metadata) in a manner described herein. For example, the network device 210 may include a router, such as a label switching router (LSR), a label edge router (LER), an ingress router, an egress router, a provider router (e.g., a provider edge router or a provider core router), a virtual router, or another type of router. Additionally, or alternatively, the network device 210 may include a gateway, a switch, a firewall, a hub, a bridge, a reverse proxy, a server (e.g., a proxy server, a cloud server, or a data center server), a load balancer, and/or a similar device. In some implementations, the network device 210 may be a physical device implemented within a housing, such as a chassis. In some implementations, the network device 210 may be a virtual device implemented by one or more computing devices of a cloud computing environment or a data center. In some implementations, a group of network devices 210 may be a group of data center nodes that are used to route traffic flow through a network.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

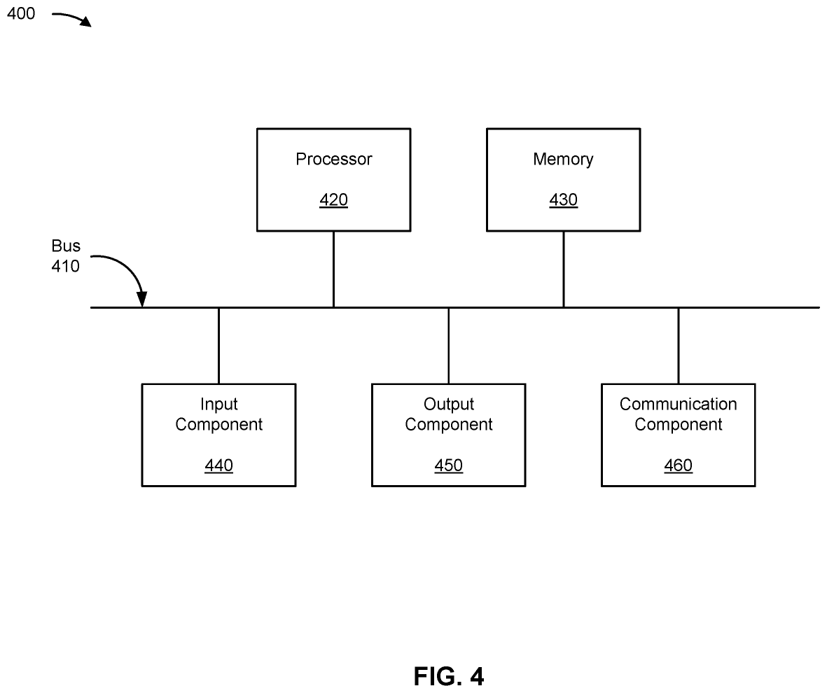

FIG. 4 is a diagram of example components of a device 400 associated with blockchain-based domain registration and device authentication. The device 400 may correspond to the registry device 105, the registrar device 110, the blockchain-based domain registrar device 115, the client device 205, and/or the network device 210. In some implementations, the registry device 105, the registrar device 110, the blockchain-based domain registrar device 115, the client device 205, and/or the network device 210 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

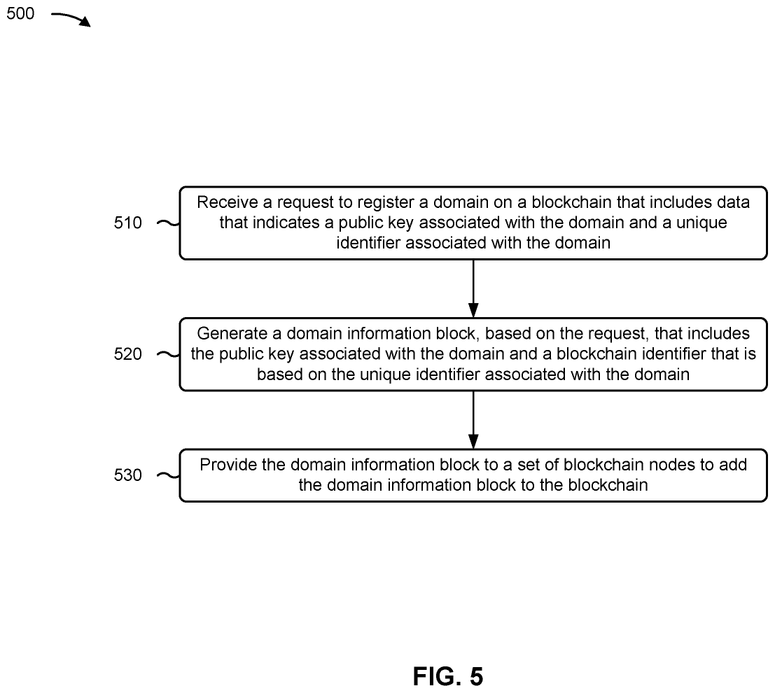

FIG. 5 is a flowchart of an example process 500 associated with blockchain-based domain registration and device authentication. In some implementations, one or more process blocks of FIG. 5 may be performed by a device (e.g., blockchain-based domain registrar device 115). In some implementations, one or more process blocks of FIG. 5 may be performed by another device or a group of devices separate from or including the device, such as a registry device (e.g., registry device 110), a registrar device (e.g., registrar device 115), a client device (e.g., client device 205) and/or a network device (e.g., network device 210). Additionally, or alternatively, one or more process blocks of FIG. 5 may be performed by one or more components of device 400, such as processor 420, memory 430, input component 440, output component 450, and/or communication component 460.

As shown in FIG. 5, process 500 may include receiving a request to register a domain on a blockchain (block 510). For example, the request may include data that indicates a public key associated with the domain and/or a unique identifier associated with the domain, as described above.

As further shown in FIG. 5, process 500 may include generating a domain information block based on the request (block 520). As an example, the domain information block may include the public key associated with the domain and a blockchain identifier that is based on the unique identifier associated with the domain, as described above.

As further shown in FIG. 5, process 500 may include providing the domain information block to a set of blockchain nodes to add the domain information block to the blockchain (block 530). For example, the device may provide the domain information block to a set of blockchain nodes and the set of blockchain nodes may validate the domain information block before adding the domain information block to the blockchain.

In some implementations, the blockchain may include one or more forks such that the blockchain includes a plurality of layers that are each associated with one or more top-level domains. For example, the domain information block may be added to one of the plurality of layers based on a top-level domain associated with the domain being registered corresponding to a top-level domain included in the one or more top-level domains associated with the one of the plurality of layers, as described above.

Additionally, or alternatively, the blockchain may include one or more forks such that the blockchain includes a plurality of layers that are each associated with a range of blockchain identifiers. For example, the domain information block may be added to one of the plurality of layers based on the blockchain identifier associated with the domain being registered being within the range of blockchain identifiers associated with the one of the plurality of layers.

Additionally, or alternatively, the blockchain include may include one or more forks such that the blockchain includes a plurality of layers where at least one of the plurality of layers is associated with one or more domain expiration events. For example, the domain information block may be added to the at least one of the plurality of layers based on a domain expiration event associated with the domain being registered corresponding to a domain expiration event included in the one or more domain expiration events associated with the at least one of the plurality of layers, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a request to register a domain on a blockchain,
wherein the request includes data that indicates:
a public key associated with the domain; and
a unique identifier associated with the domain; and
generating, by the device, a domain information block based on the request,
wherein the domain information block includes the public key associated with the domain and a blockchain identifier that is based on the unique identifier associated with the domain; and
providing, by the device, the domain information block to a set of blockchain nodes to add the domain information block to the blockchain.

2. The method of claim 1, wherein the blockchain includes one or more forks such that the blockchain includes a plurality of layers that are each associated with one or more top-level domains.

3. The method of claim 2, wherein the domain information block is added to one of the plurality of layers based on a top-level domain associated with the domain being registered corresponding to a top-level domain included in the one or more top-level domains associated with the one of the plurality of layers.

4. The method of claim 1, wherein the blockchain includes one or more forks such that the blockchain includes a plurality of layers that are each associated with a range of blockchain identifiers.

5. The method of claim 4, wherein the domain information block is added to one of the plurality of layers based on the blockchain identifier associated with the domain being registered being within the range of blockchain identifiers associated with the one of the plurality of layers.

6. The method of claim 1, wherein the blockchain includes one or more forks such that the blockchain includes a plurality of layers, and
wherein at least one of the plurality of layers is associated with one or more domain expiration events.

7. The method of claim 6, wherein the domain information block is added to the at least one of the plurality of layers based on a domain expiration event associated with the domain being registered corresponding to a domain expiration event included in the one or more domain expiration events associated with the at least one of the plurality of layers.

8. A device, comprising:
one or more processors configured to:
receive a first message from a client device,
wherein the first message indicates a random parameter;
generate, using a private key, a digital signature based on the random parameter;
provide, to the client device, a second message that indicates:
the digital signature; and
a blockchain identifier that is based on a unique identifier associated with a domain that corresponds to the device,
wherein the blockchain identifier enables the client device to retrieve a public key associated with the domain from a blockchain and to validate the digital signature using the public key; and
perform a secure communication protocol with the client device based on the client device validating the digital signature using the public key.

9. The device of claim 8, wherein the blockchain identifier enables the client device to retrieve the unique identifier from a domain information block that is on the blockchain and validate the unique identifier based on information that is stored in a domain name registry.

10. The device of claim 8, wherein the unique identifier is a domain name.

11. The device of claim 8, wherein the unique identifier associated with the domain is based on information provided by an owner of the domain to a domain name registrar, and
wherein the information is stored in a domain name registry associated with the domain name registrar.

12. The device of claim 8, wherein the public key is included in a domain information block that is on the blockchain.

13. The device of claim 8, wherein the public key is bound to an identity associated with an owner of the domain.

14. The device of claim 8, wherein the blockchain identifier corresponds to a domain information block on the blockchain that is associated with the domain, and
wherein the domain information block includes information that indicates an expiration event associated with the domain.

15. A non-transitory computer-readable medium storing a set of instructions, the set of instructions comprising:
one or more instructions that, when executed by one or more processors of a client device, cause the client device to:
provide a first message to a network device,
wherein the first message indicates a random parameter;
receive, from the network device, a second message,
wherein the second message includes a digital signature based on the random parameter and a blockchain identifier associated with a domain that corresponds to the device;
obtain a domain name and a public key associated with the domain from a blockchain based on the blockchain identifier;
verify the domain name and the digital signature, wherein the digital signature is verified using the public key; and
authenticate the network device based on verifying the domain name and the digital signature.

16. The non-transitory computer-readable medium of claim 15, wherein the one or more instructions, that cause the client device to obtain the domain name and the public key associated with the domain from the blockchain based on the blockchain identifier, cause the client device to:
retrieve the domain name and the public key from a domain information block that is on the blockchain based on the blockchain identifier.

17. The non-transitory computer-readable medium of claim 15, wherein the one or more instructions, that cause the client device to verify the domain name associated with the domain, cause the client device to:
determine that the domain name associated with the domain is stored in a domain name registry; and
verify the domain name associated with the domain based on determining that the domain name associated with the domain is stored in the domain name registry.

18. The non-transitory computer-readable medium of claim 15, wherein the public key is bound to an identity associated with an owner of the domain.

19. The non-transitory computer-readable medium of claim 15, wherein the domain name is stored in a domain name registry associated with a domain name registrar.

20. The non-transitory computer-readable medium of claim 15, wherein the blockchain identifier corresponds to a domain information block on the blockchain that is associated with the domain,
wherein the domain information block includes information that indicates a domain expiration event associated with the domain.
